(19) United States
(12) Patent Application Publication
(10) Pub. No.: US 2025/0220551 A1
(43) Pub. Date: Jul. 3, 2025

(54) WIRELESS COMMUNICATION METHOD AND APPARATUS, AND DEVICE AND STORAGE MEDIUM

(71) Applicant: GUANGDONG OPPO MOBILE TELECOMMUNICATIONS CORP., LTD., Dongguan (CN)

(72) Inventor: Yang XU, Dongguan (CN)

(21) Appl. No.: 19/087,884

(22) Filed: Mar. 24, 2025

Related U.S. Application Data
(63) Continuation of application No. PCT/CN2022/123474, filed on Sep. 30, 2022.

(51) Int. Cl. H04W 40/22; H04W 60/04; H04W 76/20

(52) U.S. Cl. CPC H04W 40/22; H04W 60/04; H04W 76/20

(57) ABSTRACT

Provided is a terminal device including a processor, a memory for storing a computer program, and a transceiver. The processor is configured to call and execute the computer program stored in the memory to send first information to a first network device through the transceiver, the first information being used to indicate at least one first parameter supported by the terminal device and/or at least one second parameter not supported by the terminal device. The at least one first parameter is related to a user equipment (UE) policy and the at least one second parameter IS related to the UE policy. There is also provided a first network device.

### CROSS-REFERENCE TO RELATED APPLICATION

This is a continuation application of International Patent Application No. PCT/CN2022/123474 filed on Sep. 30, 2022, the disclosure of which is incorporated by reference in its entirety.

### BACKGROUND

A User Equipment (UE) policy includes a UE Route Selection Policy (URSP). URSP rules in the URSP determine a binding relationship between application data and Protocol Data Unit (PDU) sessions, and also determine what kind of PDU session the UE needs to establish to satisfy this binding relationship. That is, the UE searches for or establishes a PDU session for the application data according to URSP parameters in the URSP rules.

The URSP parameters in the URSP rules, such as an Application Descriptor parameter in a Traffic Descriptor, may not be supported or recognized by a terminal, which causes some URSP rules issued by a network side to never be executed by the terminal, resulting in a waste of resources.

### SUMMARY

Embodiments of the present disclosure relate to the technical field of mobile communications, and in particular to a terminal device and a network device.

Embodiments of the present disclosure provide a terminal device and a first network device.

The terminal device provided by the embodiments of the present disclosure includes a processor, a memory for storing a computer program, and a transceiver. The processor is configured to call and execute the computer program stored in the memory to send first information to a first network device through the transceiver, the first information being used to indicate at least one first parameter supported by the terminal device and/or at least one second parameter not supported by the terminal device. The at least one first parameter is related to a UE policy and the at least one second parameter is related to the UE policy.

The first network device provided by the embodiments of the present disclosure a processor, a memory for storing a computer program, and a transceiver. The processor is configured to call and execute the computer program stored in the memory to: receive first information from a terminal device through the transceiver, and send the first information to a second network device through the transceiver, the first information is used to indicate at least one first parameter supported by the terminal device and/or at least one second parameter not supported by the terminal device. The at least one first parameter is related to a UE policy and the at least one second parameter is related to the UE policy.

### BRIEF DESCRIPTION OF THE DRAWINGS

The accompanying drawings described herein are intended to provide a further understanding of the present disclosure, and constitute a part of the present disclosure, and the schematic embodiments of the present disclosure and the description thereof are intended to explain the present disclosure, and do not constitute an undue limitation of the present disclosure, and wherein:

FIG. 1 is a schematic diagram of an application scenario according to an embodiment of the present disclosure.

FIG. 2 is a schematic diagram of an application scenario provided by an embodiment of the present disclosure.

FIG. 3 is an optional schematic flowchart of a UE configuration update (UCU) process provided by an embodiment of the present disclosure.

FIG. 4 is an optional schematic flowchart of a wireless communication method provided by an embodiment of the present disclosure.

FIG. 5 is an optional schematic flowchart of a wireless communication method provided by an embodiment of the present disclosure.

FIG. 6 is an optional schematic diagram of an association relationship between URSP rules and PDU sessions provided by an embodiment of the present disclosure.

FIG. 7 is an optional schematic flowchart of a PDU session establishment procedure provided by an embodiment of the present disclosure.

FIG. 8 is an optional schematic flowchart of a wireless communication method provided by an embodiment of the present disclosure.

FIG. 9 is an optional schematic flowchart of a wireless communication method provided by an embodiment of the present disclosure.

FIG. 10 is an optional schematic flowchart of a wireless communication method provided by an embodiment of the present disclosure.

FIG. 11 is an optional schematic flowchart of a wireless communication method provided by an embodiment of the present disclosure.

FIG. 12 is an optional schematic flowchart of a wireless communication method provided by an embodiment of the present disclosure.

FIG. 13 is an optional schematic flowchart of a wireless communication method provided by an embodiment of the present disclosure.

FIG. 14 is an optional schematic flowchart of a wireless communication method provided by an embodiment of the present disclosure.

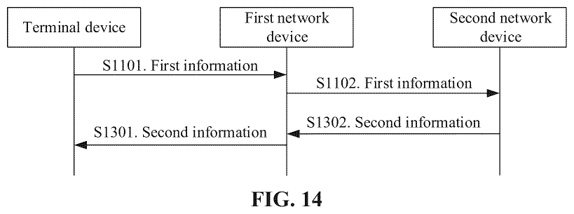

FIG. 15 is an optional schematic flowchart of a wireless communication method provided by an embodiment of the present disclosure.

FIG. 16 is an optional schematic flowchart of a wireless communication method provided by an embodiment of the present disclosure.

FIG. 17 is an optional schematic flowchart of a wireless communication method provided by an embodiment of the present disclosure.

FIG. 18 is an optional schematic structural diagram of a wireless communication apparatus provided by an embodiment of the present disclosure.

FIG. 19 is an optional schematic structural diagram of a wireless communication apparatus provided by an embodiment of the present disclosure.

FIG. 20 is an optional schematic structural diagram of a wireless communication apparatus provided by an embodiment of the present disclosure.

FIG. 21 is a schematic structural diagram of a communication device according to an embodiment of the present disclosure.

FIG. 22 is a schematic structural diagram of a chip according to an embodiment of the present disclosure.

FIG. 23 is a schematic block diagram of a communication system provided by an embodiment of the present disclosure.

### DETAILED DESCRIPTION

The technical solution of the embodiments of the present disclosure will be described below in conjunction with the drawings in the embodiments of the present disclosure, and it will be apparent that the described embodiments are part of the embodiments of the present disclosure, but not all of them. Based on the embodiments in the present disclosure, all other embodiments obtained by those of ordinary skill in the art without creative work shall fall within the scope of protection of the present disclosure.

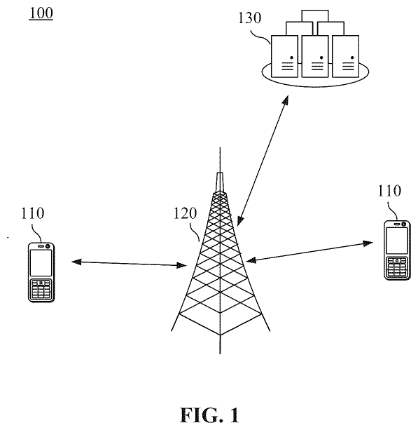

FIG. 1 is a schematic diagram of an application scenario according to an embodiment of the present disclosure.

As illustrated in FIG. 1, the communication system 100 may include terminal devices 110 and a network device 120. The network device 120 may communicate with the terminal devices 110 through an air interface. Multi-service transmission is supported between the terminal devices 110 and the network device 120.

It is to be understood that embodiments of the present disclosure are exemplarily illustrative only with the communication system 100, but are not limited thereto. That is, the technical solution of the embodiments of the present disclosure may be applied to various communication systems, such as a Long Term Evolution (LTE) system, an LTE Time Division Duplex (TDD), a Universal Mobile Telecommunications System (UMTS), an Internet of Things (IoT) system, a Narrow Band Internet of Things (NB-IoT) system, an enhanced Machine-Type Communication (eMTC) system, a 5G communication system (also called an NR communication system), or a future communication system, etc.

In the communication system 100 illustrated in FIG. 1, the network device 120 may be an access network device that communicates with the terminal devices 110. The access network device may provide communication coverage for a particular geographic area and may communicate with the terminal devices 110 (e.g. UE) located within the coverage area.

The network device 120 may be an Evolutional Node B (CNB or eNodeB) in a Long Term Evolution (LTE) system, or a gNB in a Next Generation Radio Access Network (NG RAN) device or an NR system, or a wireless controller in a Cloud Radio Access Network (CRAN). Or, the network device 120 may be a relay station, an access point, an in-vehicle device, a wearable device, a hub, a switch, a bridge, a router, or a network device in a future evolved Public Land Mobile Network (PLMN), etc.

The terminal device 110 may be any terminal device including but not limited to a terminal device in wired or wireless connection with the network device 120 or other terminal devices.

For example, the terminal device 110 may refer to an access terminal, UE, a user unit, a user station, a mobile station, a mobile platform, a remote station, a remote terminal, a mobile device, a user terminal, a terminal, a wireless communication device, a user agent, or a user device. The access terminal may be a cellular phone, a cordless phone, a session initiation protocol (SIP) telephone, an IoT device, a satellite handheld terminal, a wireless local loop (WLL) station, a personal digital assistant (PDA), a handheld device with wireless communication function, a computing device or other processing device connected to a wireless modem, an in-vehicle device, a wearable device, a terminal device in the 5G network or a terminal device in the future evolved network, etc.

The wireless communication system 100 may also include a core network device 130 that communicates with a base station. The core network device 130 may be a 5G Core (5GC) device, for example, an Access and Mobility Management Function (AMF), for another example, an Authentication Server Function (AUSF), for another example, a User Plane Function (UPF), and for another example, a Session Management Function (SMF). Optionally, the core network device 130 may also be an Evolved Packet Core (EPC) device of the LTE network, for example, a Session Management Function+Core Packet Gateway (SMF+PGW-C) device. It is to be understood that SMF+PGW-C can achieve the same functions as SMF and PGW-C simultaneously. In a process of network evolution, the core network device may also be called by other names, or a new network entity may be formed by dividing the functions of the core network, which is not limited by the embodiments of the present disclosure.

Various functional units in the communication system 100 may also establish connections with each other through a next generation (NG) network interface to realize communication.

For example, the terminal device establishes an air interface connection with an access network device through a Uu interface for transmitting user plane data and control plane signaling. The terminal device may establish a control plane signaling connection with an AMF through an NG interface 1 (abbreviated as N1). The access network device, such as a base station (i.e., gNB) in the next generation radio access, may establish a user plane data connection with a UPF through an NG interface 3 (abbreviated as N3). The access network device may establish a control plane signaling connection with the AMF through an NG interface 2 (abbreviated as N2). The UPF may establish a control plane signaling connection with an SMF through an NG interface 4 (abbreviated as N4). The UPF may exchange user plane data with a data network through an NG interface 6 (abbreviated as N6). The AMF may establish a control plane signaling connection with the SMF through an NG interface 11 (abbreviated as N11). The SMF may establish a control plane signaling connection with a Policy Control Function (PCF) through an NG interface 7 (abbreviated as N7).

FIG. 1 exemplarily illustrates a base station, a core network device and two terminal devices. Optionally, the wireless communication system 100 may include multiple base stations, and other numbers of the terminal devices may be included within the coverage of each base station, which is not limited by embodiments of the present disclosure.

It is to be noted that FIG. 1 is only exemplarily illustrative of a system to which the present disclosure applies, and of course, the method illustrated in the embodiments of the present disclosure may also be applied to other systems. In addition, the terms “system” and “network” of the present disclosure are often used interchangeably herein. In the present disclosure, the term “and/or” is used to describe an association relationship of associated objects, and represents that there may be three relationships. For example, A and/or B may represent the following three situations: i.e., independent existence of A, existence of both A and B and independent existence of B. In addition, the character “/” in the present disclosure generally represents that an “or” relationship is formed between the previous and next associated objects. It is to be understood that the “indicate” mentioned in embodiments of the present disclosure may be a direct indication, may be an indirect indication, or may represent an association relationship. For example, A indicates B, which may mean that A directly indicates B, for example, B may be obtained through A. It may also mean that A indirectly indicates B, for example, A indicates C, and B may be obtained by C. It may also indicate that there is an association relationship between A and B. It is to be understood that “correspond” mentioned in the embodiments of the present disclosure may mean that there is a direct correspondence or an indirect correspondence relationship between the two, may also mean that there is an association relationship between the two, may also be a relationship between indication and being indicated, configuration and being configured, etc. It is also to be understood that the “predefined” or “predefined rules” referred to in embodiments of the present disclosure may be implemented by pre-storing corresponding codes, tables, or other manners that may be used to indicate relevant information in devices (e.g., including the terminal devices and network devices), the specific implementation of which is not limited by the present disclosure. For example, predefined may refer to what is defined in the protocol. It should also be understood that, in embodiments of the present disclosure, the “protocol” may refer to standard protocols in the communication field, such as LTE protocol, NR protocol, and related protocols applied in future communication systems, which are not limited herein.

In order to facilitate understanding of the technical solution of the embodiments of the present disclosure, the following related technologies of the embodiments of the present disclosure are described, and these related technologies, as optional solutions, may be arbitrarily combined with the technical solution of the embodiments of the present disclosure, all of which belong to the protection scope of the embodiments of the present disclosure.

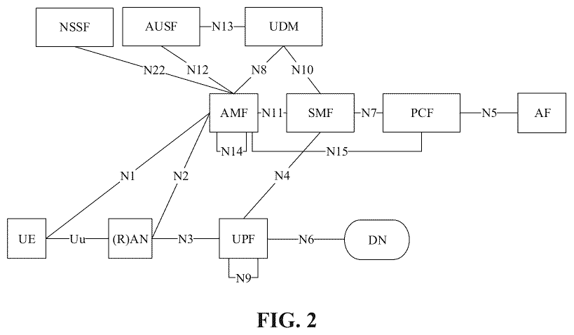

Network architecture of the 5G communication system is illustrated in FIG. 2, which includes the following network elements: an AMF, a Session Management Function (SMF), a Policy Control Function (PCF), an Authentication Server Function (AUSF), a Unified Data Management (UDM), a UPF, a Network Slice Selection Function (NSSF) and an Application Function, (AF). Further, the network architecture also includes a (Radio) Access Network (R)AN, UE, and a data network (DN).

The UE may be connected to the AMF, the (R)AN may be connected to the AMF, the (R)AN may also be connected to the UPF, the UPF may be connected to the SMF and the DN, respectively, the AMF may be connected to the SMF, the UDM, the PCF, the NSSF, and the AUSF, respectively, and the SMF may be connected to the PCF and the UDM, respectively. The PCF is connected to the AF. Both the AMF and SMF may obtain data, such as a user subscription data, from the UDM, and both the AMF and SMF may obtain policy data from the PCF. For example, the PCF element obtains user subscription data from the UDM and sends it to the AMF and the SMF, and then the AMF and the SMF send the user subscription data to the (R)AN, the UE, the UPF, and the like. The SMF is responsible for an execution of policies related to the sessions, the AMF is responsible for execution of policies related to access and UE policies, and an issuance and update of policies on the AMF and the SMF are controlled by the PCF.

As illustrated in FIG. 2, interfaces and connections in the network architecture may include: Uu, N1, N2, N3, N4, N5, N6, N7, N8, N10, N11, N12, N13, N14, N15, N22. Uu is an interface between the terminal device and the RAN, N1 is a control plane interface between the terminal device and the AMF network element, and N1 is used for transmitting control signaling between a user device and a control plane of a core network, and specifically, messages in N1 connections may be transmitted through a connection between the terminal device and the RAN and an N2 connection between the RAN and the AMF network element. N2 is a control plane interface between the RAN and the AMF network element. N3 is an interface between the RAN and UPF. N4 is an interface between the SMF network element and the UPF, and N4 is used for transmitting control signaling between the SMF network element and the UPF. N5 is an interface between the PCF and the AF, N6 is an interface between the UPF and the DN, N7 is an interface between the SMF network element and the PCF, N8 is an interface between the AMF network element and the UDM network element, N10 is an interface between the UDM network element and the SMF network element, N11 is an interface between the AMF network element and the SMF network element, N12 is an interface between the AUSF network element and the AMF network element, N13 is an interface between the AUSF network element and the UDM, N14 is an inter-AMF interface, N15 is an interface between the AMF network element and the PCF network element, and N22 is an interface between the NSSF network element and the AMF network element.

The UE policy may include a WLAN Selection Policy (WLANSP), a UE Route Selection Policy (URSP), an Internet of Vehicles policy, and the like. The WLANSP includes multiple rules, and the rules in the WLANSP are called WLANSP rules, which are used for the UE to select a WLAN access point. The URSP includes multiple rules, and the rules in URSP are called URSP rules, which are used for the terminal device to bind specific application data flow to a specific session (such as a PDU session). Based on different traffic types, UE policies may also be divided into Internet of Vehicles policies, Internet of Things policies, etc., mechanisms of which are the same as that of the URSP.

For the UE policy, the PCF and the UE monitor, through a container, information related to the UE policy, such as a content of the UE policy and UE policy identifiers. In an uplink direction, the container is sent by the UE to the AMF through a Non Access Stratum (NAS) message, and the AMF continues to transmit the container to the PCF transparently (without perception or modification). On the contrary, in the downlink direction, the container is sent by the PCF to the AMF, and the AMF transparently transmits the container to the UE through the NAS message.

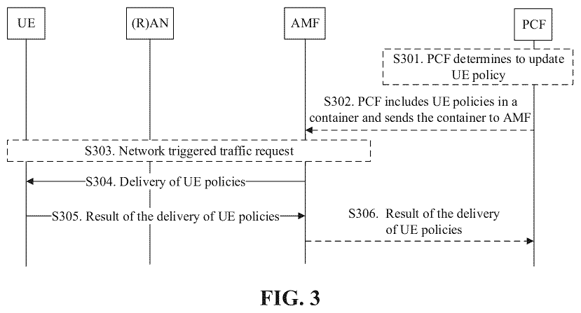

Based on the network architecture illustrated in FIG. 2, the UE Policy is implemented through a UE Configuration Update (UCU) process illustrated in FIG. 3. As illustrated in FIG. 3, the PCF includes a policy to be updated in a container and sends it to the AMF, and the AMF directly forwards it to the UE using the NAS message.

The UCU process is illustrated in FIG. 3, which includes the following operations S301 to S306.

At S301, PCF decides to update UE policy.

At S302, the PCF includes UE policies into a container and sends the container to AMF.

The PCF may send an NAS message (Namf_Communication_N1N2MessageTransfer) to the AMF, and the NAS message includes the container.

At S303, a network triggers service request.

At S304, the AMF delivers the UE policies to the UE.

The AMF includes the UE policies in the container and transparently transmits the container to the UE.

At S305, the UE sends a result of the delivery of UE policies to the AMF.

The result of the delivery of UE policies may indicate whether the delivery of UE policies was successful. The UE may transmit the result of the delivery of UE policies to the AMF through the container.

At S306, the AMF sends the result of the delivery of UE policies to the PCF.

The AMF transparently transmits the result of the delivery of UE policies to the PCF through the container, where the AMF may transmit the NAS message (such as Namf_N1MessageNotify) to the PCF.

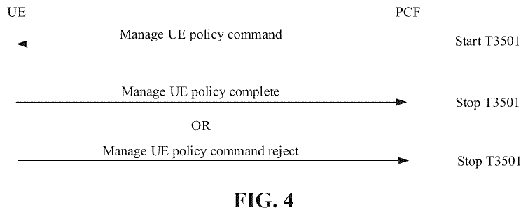

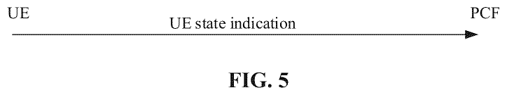

In order to transmit the UE policy, a cause value of a UE policy container is introduced both in a downlink NAS message and an uplink NAS message, that is, by adding a “UE policy container” cause value in a payload container. When AMF finds the cause value in the payload container, AMF will perform a function of transparent transmission. The UE policy container is used to carry messages between the PCF and the UE, including a manage UE policy command sent by the PCF to the UE and a manage UE policy complete or a manage UE policy command reject sent by the UE to the PCF as illustrated in FIG. 4, and carry a UE state indication sent by the UE to the PCF as illustrated in FIG. 5. The PCF starts a timer T3501 after sending the manage UE policy command and stops the timer T3501 after receiving the manage UE policy complete or the manage UE policy command reject.

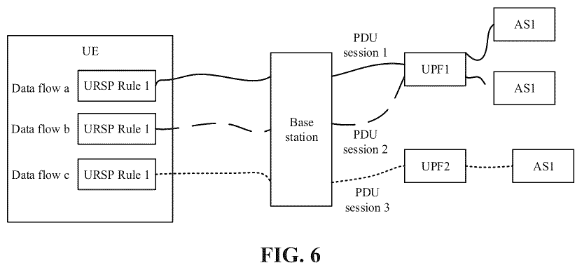

The URSP rules included in URSP determine a binding relationship between the application data and the PDU sessions, and also determine what kind of PDU session the UE needs to establish to satisfy this binding relationship. As illustrated in FIG. 6, data flow a is bound to PDU session 1 according to URSP rule 1, data flow b is bound to PDU session 2according to URSP rule 2, and data flow c is bound to PDU session 3 according to URSP rule 3,and each PDU session corresponds to a set of attribute parameters of the PDU session. As illustrated in FIG. 6, the PDU session 1 is a session on UPF1 and application server (AS) 1, the PDU session 2 is a session on UPF1 and AS2, and the PDU session 3 is a session on UPF2 and AS3.

Session attribute parameters corresponding to each PDU session include: Single-Network Slice Selection Assistant Information (S-NSSAI), a Data Network Name (DNN), a PDU Session Type), a Session and Service Continuity (SSC) Mode.

The terminal device may carry the above session attribute parameters in a PDU session establishment request, and if some of the session attribute parameters are not carried, the network device may fill in session attribute parameters for the PDU session. For example, when the PDU session establishment request includes: PDU Session id=1, DNN-1, and PDU Sessiontype=IPv4, the SMF receives the request and fills in other attribute parameters such as S-NSSAI=1, SSC Mode=1.

In this case, the terminal device and/or the network device may save which attribute parameters in a successfully established PDU session are requested by the terminal and which attribute parameters are filled in by the network.

Each URSP rule consists of a traffic descriptor and a set of route selection descriptions (RSD).

The traffic descriptor in URSP is used to describe a specific service (such as an application data flow in FIG. 6). For example, a micro-blog service may be described in a range of IP@ 1-9, and for another example, an IP Multimedia Subsystem (IMS) service may be described by an IMS DNN. There may be one or more values for S-NSSAI and one or more values for DNN in RSDs, and other parameters only have one value. Therefore, each RSD may correspond to one or more combinations of parameters, each combination of parameters is a set of features of a PDU session, and traffic data corresponding to the traffic descriptor may be transmitted in a PDU session corresponding to a certain combination of parameter values in the RSD. When the application data flow described by the traffic descriptor appears, the UE may select a parameter combination according to component values in the corresponding RSD to initiate a PDU session establishment request.

Each time the UE initiates a PDU session establishment request, it includes a set of session data parameters in the request message, that is, a set of combinations of parameter values in RSD list in a certain URSP rule.

At present, parameters included in the traffic descriptor and parameters included in RSD are illustrated in Tables 1 and 2 below, respectively.

TABLE 1
Traffic descriptor and corresponding RSD list

| | | | PCF permitted | |
|---|---|---|---|---|
| Information | | | to modify in a | |
| name | Description | Category | UE context | Scope |
| Rule Precedence | Determines the order the URSP | Mandatory | Yes | UE |
| | rule is enforced in the UE. | | | context |
| Traffic | This part defines the traffic | | | |
| descriptor | descriptors for the policy | | | |
| Application | Application identifier(s) | Optional | Yes | UE |
| identifiers | | | | context |
| Domain | Destination FQDN(s) | Optional | Yes | UE |
| descriptors | | | | context |
| IP descriptors | IP 3 tuple(s) (destination IP address | Optional | Yes | UE |
| | or IPv6 network prefix, destination | | | context |
| | port number, protocol ID of the | | | |
| | protocol above IP) | | | |
| Non-IP | Descriptor(s) for non-IP traffic | Optional | Yes | UE |
| descriptors | | | | context |
| DNN | This is matched against the DNN | Optional | Yes | UE |
| | information provided by the | | | context |
| | application. | | | |
| Connection | This is matched against the | Optional | Yes | UE |
| Capabilities | information provided by a UE | | | context |
| | application when it requests a | | | |
| | network connection with certain | | | |
| | capabilities. (NOTE 4) | | | |
| List of Route | A list of Route Selection | Mandatory | | |
| Selection | Descriptors. The components of a | | | |
| Descriptors | Route Selection Descriptor are | | | |
| | described in table 6.6.2-2. | | | |

In Table 1, the traffic descriptor includes the following parameters, which can be understood as: domain descriptors, IP descriptors, Non-IP descriptors, DNN, and connection capabilities.

TABLE 2
Route selection descriptor

| | | | PCF | |
|---|---|---|---|---|
| | | | permitted to | |
| | | | modify in a | |
| Information name | Description | Category | UE context | Scope |
| Route Selection | Determines the order in which | Mandatory | Yes | UE |
| Descriptor | the Route Selection Descriptors | | | context |
| Precedence | are to be applied. | | | |
| Route selection | This part defines the route | Mandatory | | |
| components | selection components | | | |
| SSC Mode | One single value of SSC mode. | Optional | Yes | UE |
| Selection | | | | context |
| Network Slice | Either one single value or a list of | Optional | Yes | UE |
| Selection | values of S-NSSAI(s). | | | context |
| DNN Selection | Either one single value or a list of | Optional | Yes | UE |
| | values of DNN(s). | | | context |
| PDU Session Type | One single value of PDU Session | Optional | Yes | UE |
| Selection | Type | | | context |
| Non-seamless | Indicates if the traffic of the | Optional | Yes | UE |
| Offload indication | matching application is to be | | | context |
| | offloaded to non-3GPP access | | | |
| | outside of a PDU Session. | | | |
| ProSe Layer-3 UE- | Indicates if the traffic of the | Optional | Yes | UE |
| to-Network Relay | matching application is to be sent | | | context |
| Offload indication | via a ProSe Layer-3 UE-to- | | | |
| | Network Relay outside of a PDU | | | |
| | session. | | | |
| Access Type | Indicates the preferred Access | Optional | Yes | UE |
| preference | Type (3GPP or non-3GPP) when | | | context |
| | the UE establishes a PDU | | | |
| | Session for the matching | | | |
| | application. | | | |
| PDU Session Pair | An indication shared by | Optional | Yes | UE |
| ID | redundant PDU Sessions as | | | context |
| | described in clause 5.33.2.1 of TS | | | |
| | 23.501 [2]. | | | |
| RSN | The RSN as described in clause | Optional | Yes | UE |
| | 5.33.2.1 of TS 23.501 [2]. | | | context |
| Route Selection | This part defines the Route | Optional | | |
| Validation | Validation Criteria components | | | |
| Criteria | | | | |
| Time Window | The time window when the | Optional | Yes | UE |
| | matching traffic is allowed. The | | | context |
| | RSD is not considered to be valid | | | |
| | if the current time is not in the | | | |
| | time window. | | | |
| Location Criteria | The UE location where the | Optional | Yes | UE |
| | matching traffic is allowed. The | | | context |
| | RSD rule is not considered to be | | | |
| | valid if the UE location does not | | | |
| | match the location criteria. | | | |

In Table 2, route selection components include the following parameters: an SSC mode selection, a Network Slice Selection, a DNN selection, a PDU Session Type Selection, a Non-seamless Offload indication, a ProSe Layer-3 UE-to-Network Relay Offload indication, an Access Type preference, a PDU Session Pair ID, a regional service node (RSN). Parameters in Route Selection Validation Criteria include a Time Window and Location Criteria.

The mechanism by which UE associates application data flows with corresponding PDU sessions based on URSP rules for transmission is as follows. When data appears in the application layer, the UE uses parameters in the URSP rules to check whether features of the application data match a traffic descriptor of a certain rule in the URSP rules, and an order of checking is determined according to precedence in the URSP rules, that is, the UE sequentially checks a matching situation based on a precedence order, and when one URSP rule is matched, the UE performs binding of PDU session using a RSD list under the URSP rule.

When one URSP rule is matched, the UE performs the following processing:
1) UE firstly searches whether a currently established PDU session has valid RSD parameters that satisfy the matched URSP rule, and if so, the matched application data is bound to the PDU session for transmission, otherwise:
2) UE tries to establish a PDU session according to a precedence order of valid RSDs. Attribute parameters of an RSD with high precedence are preferentially used to establish the PDU session. If a certain parameter in the RSD has one or more values, the UE selects one of them to combine with other parameters to establish the PDU session:
2.1) if the PDU session was successfully established, the UE binds the application data to the PDU session for transmission;
2.2) if the PDU session fails to be established, the UE attempts to establish a PDU session again based on a combination of parameters in the RSD with high precedence or using a combination of parameters in a RSD with secondary precedence.

If a suitable PDU session cannot be found for binding according to the matched URSP rule, the UE searches whether a traffic descriptor in a URSP rule with secondary precedence can match features of the application data flow according to the precedence order, and if yes, and the previously described process is repeated.

The above process of finding a suitable PDU session for application data is called an evaluation process, that is, a suitable PDU session for binding is found or established. The RSD in the URSP rule used by the UE are considered to be valid RSD (which is used to perform the above evaluation process) only if the following conditions are met:
if there is an S-NSSAI in the RSD, the S-NSSAI must belong to one of an Allowed NSSAI (i.e., non-roaming) or a Mapping of Allowed NSSAI (i.e., roaming);
if there is a DNN in the RSD and the DNN is a local area data network data network name (LADN DNN), the UE must be located within a valid area corresponding to the LADN;
if there is an Access Type Preference in the RSD and the Access Type Preference is set to Multi-Access, the UE must support an Access Traffic Steering, Switching, Splitting (ATSSS) function;
if there is a Timer window and Location criteria in the RSD, then the required time and location conditions must be met.

If an RSD does not satisfy the above conditions, the UE does not use the RSD for binding of data flow or establishment of PDU session.

According to the above evaluation process, after an initiation of PDU session establishment is rejected, the UE may request the establishment of PDU session again according to the RSD parameters.

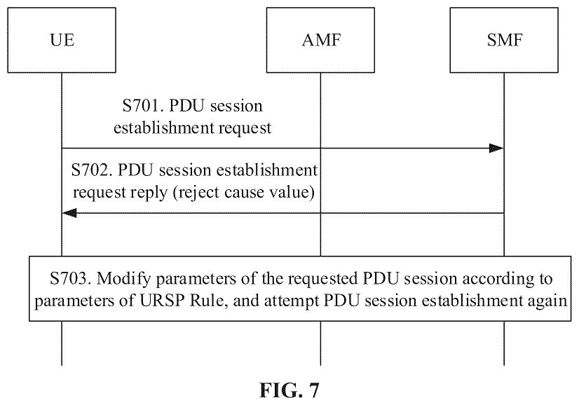

FIG. 7 illustrates a PDU session establishment procedure, which includes the following operations S701, S702, S703.

At S701, UE sends a PDU session establishment request to an SMF.

The UE carries PDU session parameters in a PDU session establishment request message, and the PDU session parameters may include one or more of the following: DNN, S-NSSAI, PDU Session Type, SSC Mode, and PDU Session ID. If the network side rejects the session establishment request, a reject cause value will be carried.

At S702, the SMF returns a PDU session establishment request reply to the UE.

When the SMF rejects to establish the PDU session establishment request, a reject cause value will be carried.

At S703, the UE modifies the requested PDU session parameters according to RSD parameters of the URSP Rule, and tries to establish the PDU session again.

In the related art, parameters in URSP rules, such as an application descriptor parameter in the traffic descriptor, may not be supported or identified by the terminal, resulting in a situation that some URSP rules issued by the network side may never be executed by the terminal, but the network side does not know this situation.

Therefore, status information of execution of URSP rules is known only to the terminal device, but not to the network side, and thus it is uncertain whether the URSP parameters sent to the terminal device are reasonable or used. Therefore, a mechanism is needed to help the network side know which URSP parameters are supported by the terminal device, so that a 5G network side (such as PCF) can modify the URSP parameters according to the situation.

In order to facilitate understanding of the technical solution of the embodiments of the present disclosure, the technical solution of the present disclosure will be described in detail by specific embodiments below. The above related technologies, as optional solutions, may be combined with the technical solution of the embodiments of the present disclosure arbitrarily, all of which belong to the protection scope of the embodiments of the present disclosure. Embodiments of the present disclosure include at least some of the following content.

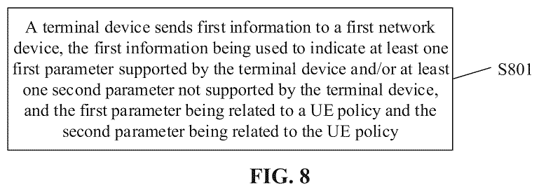

As illustrated in FIG. 8, the wireless communication method provided by the embodiment of the present disclosure is applied to a terminal device, and includes the following operation S801.

At S801, the terminal device sends first information to a first network device. The first information is used to indicate at least one first parameter supported by the terminal device and/or at least one second parameter not supported by the terminal device, the first parameter being related to a user equipment (UE) policy and the second parameter being related to the UE policy.

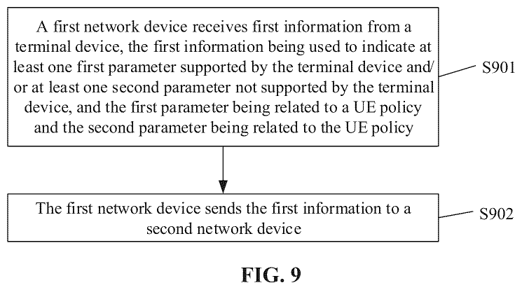

As illustrated in FIG. 9, the wireless communication method provided by the embodiment of the present disclosure is applied to a first network device, and includes the following operations S901 and S902.

At S901, the first network device receives first information from a terminal device. The first information is used to indicate at least one first parameter supported by the terminal device and/or at least one second parameter not supported by the terminal device, the first parameter being related to a UE policy and the second parameter being related to the UE policy.

At S902, the first network device sends the first information to a second network device.

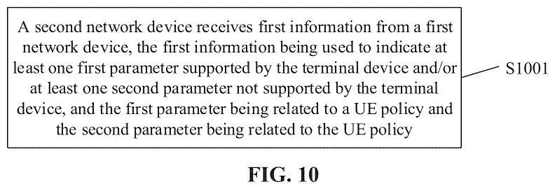

As illustrated in FIG. 10, the wireless communication method provided by the embodiment of the present disclosure is applied to a second network device, and includes the following operation S1001.

At S1001, the second network device receives first information from a first network device. The first information is used to indicate at least one first parameter supported by a terminal device and/or at least one second parameter not supported by the terminal device, the first parameter being related to a UE policy and the second parameter being related to the UE policy.

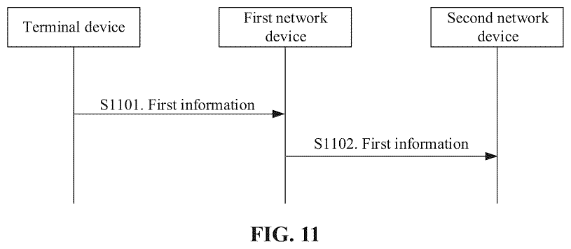

As illustrated in FIG. 11, the wireless communication method provided by the embodiment of the present disclosure is applied to a wireless communication system including a terminal device, a first network device, and a second network device, and includes the following operations S1101 and S1102.

At S1101, the terminal device sends first information to the first network device.

At S1102, the first network device sends the first information to the second network device.

The first information is used to indicate at least one first parameter supported by the terminal device and/or at least one second parameter not supported by the terminal device, the first parameter being related to a UE policy and the second parameter being related to the UE policy.

In an embodiment of the present disclosure, the terminal device sends first information to the first network device, and the first information is used to indicate at least one first parameter supported by the terminal device and/or at least one second parameter not supported by the terminal device, the first parameter is related to the UE policy, and the second parameter is related to the UE policy. Therefore, the first information can reflect a support capability of the terminal device for at least one parameter related to the UE policy, so that based on reporting of the first information, the network side can obtain the support capability of the terminal for the at least one parameter related to the UE policy to adjust contents of the UE policy of the terminal device according to the first information, thereby avoiding waste of resources caused by configuring, for the terminal device, the UE policy related parameters that are not supported by the terminal device.

The terminal device determines at least one first parameter supported by the terminal device and/or at least one second parameter not supported by the terminal device, generates first information based on the at least one first parameter and/or the at least one second parameter, and sends the first information to the first network device. The first network device sends the first information to the second network device after receiving the first information sent by the terminal device.

Optionally, the second network device is a PCF capable of controlling UE policies.

Optionally, the first network device is an AMF capable of executing UE policies.

In an embodiment of the present disclosure, the first information may be used to indicate one of the following:
at least one first parameter supported by the terminal device;
at least one second parameter not supported by the terminal device.

Optionally, the first information may only be used to indicate the at least one first parameter supported by the terminal device. It may be understood that the first information indicates at least one parameter, and the terminal device, the first network device, and the second network device default that the at least one parameter indicated by the first information is at least one first parameter supported by the terminal device.

Optionally, the first information may only be used to indicate at least one second parameter not supported by the terminal device. It may be understood that the first information indicates at least one parameter, and the terminal device, the first network device, and the second network device default that the at least one parameter indicated by the first information is at least one second parameter not supported by the terminal device.

Optionally, the first information is used to indicate at least one first parameter and at least one second parameter not supported by the terminal device. It may be understood that the first information includes first indication information and second indication information, the first indication information is used to indicate at least one first parameter supported, and the second indication information is used to indicate at least one second parameter not supported. Optionally, the first indication information and the second indication information are identification bits with different values, or are different data groups.

In an embodiment of the present disclosure, an indication manner in which the first information indicates at least one first parameter supported by the terminal device and/or at least one second parameter not supported by the terminal device includes, but is not limited to, the following manners 1 and 2.

In manner 1, the first information includes a parameter(s) or an index(s) of the parameter(s), and the parameter(s) or a parameter(s) corresponding to the parameter index(s) indicated by the first information is a first parameter(s) supported by the terminal device or a second parameter(s) not supported by the terminal device.

In manner 2, the second information includes a plurality of bits corresponding to different parameters, and for one bit, it is indicated that the terminal device supports or does not support a parameter corresponding to the bit based on different values of the bit.

For manner 1, in an example, the first information includes a parameter A, a parameter B, and a parameter C, which indicates that the at least one first parameter supported by the terminal device includes the parameter A, the parameter B, and the parameter C.

For manner 1, in an example, the first information includes parameter B and parameter C, which indicates that the at least one second parameter not supported by the terminal device includes parameter B and parameter C.

For manner 2, in an example, the first information includes three bits corresponding to the parameter A, the parameter B, and the parameter C, and values of the three bits are 1, 1, and 0, respectively. In a case where 1 indicates that a corresponding parameter is supported by the terminal device and 0 indicates that a corresponding parameter is not supported by the terminal device, the first information indicates that the terminal device supports the parameter A and the parameter B, and the terminal device does not support the parameter C.

In an embodiment of the present disclosure, for a terminal device, in the case that the first information is used to indicate at least one first parameter supported by the terminal device and at least one second parameter not supported by the terminal device, the at least one first parameter and the at least one second parameter do not include the same parameter.

In some embodiments, the at least one first parameter belongs to a UE route selection policy (URSP) parameter.

Optionally, the at least one first parameter includes a parameter(s) in a traffic descriptor and/or a parameter(s) in a route selection descriptor.

If the at least one first parameter includes the parameter(s) in the route selection descriptor, the at least one first parameter includes a parameter(s) in route selection components and/or a parameter(s) in route selection validation criteria.

In some embodiments, the at least one second parameter belongs to a URSP parameter.

Optionally, the at least one second parameter includes a parameter(s) in a traffic descriptor and/or a parameter(s) in a route selection descriptor.

If the at least one second parameter includes the parameter(s) in the route selection descriptor, the at least one second parameter includes a parameter(s) in route selection components and/or a parameter in route selection validation criteria.

In an embodiment of the present disclosure, if at least one first parameter belongs to URSP parameters and at least one second parameter belongs to the URSP parameters, then the first information is used to indicate URSP parameter(s) supported by the terminal device and/or URSP parameter(s) not supported by the terminal device.

URSP parameters are parameters in URSP rules. An URSP rule includes a traffic descriptor and a set of RSDs. The parameters of the traffic descriptor are illustrated in Table 1, including: application descriptors, Internet Protocol (IP) descriptors, domain descriptors, non-IP descriptors, a DNN and connectivity capabilities. As illustrated in Table 2, the parameters of the RSD include: parameters in the route selection components and parameters in the route validation criteria. As illustrated in Table 2, the parameters in the route selection components include: an SSC mode selection, a Network Slice Selection, a DNN selection, a PDU Session Type Selection, a Non-seamless Offload indication, a ProSe Layer-3 UE-to-Network Relay Offload indication, an Access Type preference, a PDU Session Pair ID, a regional service node (RSN). Parameters in the Route Selection Validation Criteria include a time window and location criteria.

If the at least one first parameter and/or second parameter indicated by the first information includes parameters of the traffic descriptor in Table 1, the first information is used to indicate that which parameters in Table 1 are supported by the terminal device and/or which parameters in Table 1 are not supported by the terminal device.

In an example, if the at least one first parameter includes application descriptors and IP descriptors, then the first information is used to indicate the application descriptors, the IP descriptors supported by the terminal device.

In an example, if the at least one second parameter includes: IP descriptors and connectivity capabilities, then the first information is used to indicate the IP descriptors and the connectivity capabilities not supported by the terminal device.

In an example, if the at least one first parameter includes application descriptors and IP descriptors, and the at least one second parameter includes DNN and connectivity capabilities, then the first information is used to indicate the application descriptors and the IP descriptors supported by the terminal device, as well as the DNN and the connectivity capabilities not supported by the terminal device.

If the at least one first parameter and/or the second parameter indicated by the first information includes the URSP parameter (including parameters in the RSD in Table 2), then the first information is used to indicate that which parameters in Table 2 are supported by the terminal device and/or which parameters in Table 2 are not supported by the terminal device.

In an example, if the at least one first parameter includes: an SSC mode selection and a time window, then the first information is used to indicate the SSC mode selection and the time window supported by the terminal device.

In an example, if the at least one second parameter includes an SSC mode selection and location criteria, then the first information is used to indicate the SSC mode selection and the location criteria not supported by the terminal device.

In an example, if the at least one first parameter includes an SSC mode selection and a DNN selection, and the at least one second parameter includes a time window, then the first information is used to indicate the SSC mode selection and the DNN selection supported by the terminal device, and the time window not supported by the terminal device.

If the at least one first parameter and/or second parameter indicated by the first information includes the parameters illustrated in Table 1 and Table 2, the first information is used to indicate that which parameters in Table 1 and Table 2 are supported by the terminal device and/or which parameters in Table 1 and Table 2 are not supported by the terminal device.

It is to be understood that when the at least one first parameter and/or the at least one second parameter indicated by the first information includes a parameter(s) of the traffic descriptor, the parameter(s) of the traffic descriptor includes, but is not limited to, at least one of the parameters illustrated in Table 1.

It is to be understood that when the at least one first parameter and/or the at least one second parameter indicated by the first information includes a parameter(s) of the RSD, the parameter(s) of the RSD includes, but is not limited to, at least one of the parameters illustrated in Table 2.

In some embodiments, the operation that the terminal device sends the first information to the first network device includes that the terminal device sends a first message to the first network device, the first message carrying the first information.

Correspondingly, the operation that the first network device receives the first information from the terminal device includes that the first network device receives a first message from the terminal device, the first message carrying the first information.

Optionally, the first message directly carries the first information.

Optionally, the first message includes a first UE policy container, and the first information is contained in the first UE policy container.

It is to be understood that the terminal device includes the first information in the first UE policy container, and sends the first UE policy container to the first network device through the first message.

Optionally, the first message is a NAS message.

In some embodiments, the first message includes at least one of the following:
message 1: registration request message;
message 2: UE policy configuration request message;
message 3: uplink Non-Access Stratum (UL NAS) Transport message.

For message 1, the terminal device includes and sends the first information in the registration request message initiated in a registration process or sends the first information through the first UE policy container.

After the terminal device sends the registration request message to the first network device, the first network device and the terminal device perform subsequent steps of the registration process, and after the registration is completed, the first network device returns a registration request reply message to the terminal device. The registration request reply message sent by the first network device to the terminal device may include a registration accept message, a registration reject message, or a registration complete message.

For message 2, the terminal device carries the first information in a UE policy configuration request initiated during a UE policy configuration process or sends the first information through the first UE policy container.

After the first network device has received the UE policy configuration request, the first network device and the terminal device perform subsequent steps of the UE policy configuration process, and after the UE policy configuration is completed, the first network device returns a UE policy configuration reply message to the terminal device.

For message 3, the terminal device carries the first information in the UL NAS Transport message initiated during an initiated NAS transmission process or sends the first information through the first UE policy container.

For the UL NAS Transport message, the network device is not required to return a response message.

In some embodiments, the operation that the first network device sends the first information to a second network device includes that:
the first network device sends a second message to the second network device, the second message carrying the first information.

Correspondingly, the operation that the second network device receives the first information from the first network device includes that:
the second network device receives a second message from the first network device, the second message carrying the first information.

After the first network device has received the first information from the terminal device, the first network device sends the first information to the second network device through a second message. Then, the second network device receives the first information.

Optionally, the second message including at least one of:
an access management (AM) policy association establishment message or an AM policy association modification message.

In an example, the first message is the registration request message, and the second message is the AM policy association establishment message.

In an example, the first message is the UE policy configuration request message or the UL NAS Transport message, and the second message is the AM policy association modification message.

In an embodiment of the present disclosure, a manner in which the second message carries the first information includes the following manner:
carrying manner 1: the second message includes the first UE policy container, and the first information is contained in the first UE policy container; or
carrying manner 2: the first information is contained in the second message.

In the carrying manner 1, the first network device sends the first information to the second network device through the first UE policy container.

If the first network device has received the first UE policy container from the terminal device, and the first UE policy container includes the first information, the first network device may transparently transmit the first UE policy container to the second network device directly.

The second network device has received the second message and acquires the first information from the first UE policy container in the second message.

In the carrying manner 2, the first network device directly includes the first information in a second message and sends the second message to the second network device.

If the first network device has received the first UE policy container from the terminal device, and the first UE policy container includes the first information, the first network device may acquire the first information from the first UE policy container, and directly include the first information in the second message and sends the second message to the second network device.

The second network device has received the second message and directly parses the first information from the second message.

In some embodiments, the wireless communication method provided by the terminal device further includes the following operation.

The terminal device receives a first UE policy from the first network device, wherein the first UE policy is determined based on the first information.

Correspondingly, the wireless communication method provided by the first network device further includes that: the first network device receives the first UE policy from the second network device, wherein the first UE policy is determined based on the first information; and the first network device sends the first UE policy to the terminal device.

Correspondingly, the wireless communication method provided by a second network device further includes that: the second network device sends the first UE policy to the first network device, wherein the first UE policy is determined based on the first information.

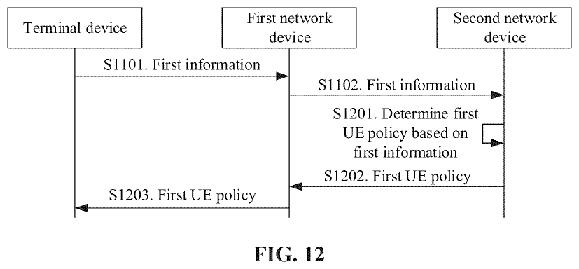

It is to be understood that the wireless communication method provided by the embodiment of the present disclosure, as illustrated in FIG. 12, further includes the following operations S1201, S1202, S1203.

At S1201, the second network device determines a first UE policy based on the first information.

At S1202, the second network device sends the first UE policy to the first network device.

At S1203, the first network device sends the first UE policy to the terminal device.

In an embodiment of the present disclosure, after the second network device has received the first information, the second network device determines a UE policy configured for the UE based on the first information.

For the at least one first parameter supported by the terminal device indicated by the first information, the first UE policy may be adjusted based on the at least one first parameter. For example, the first UE policy includes at least one first parameter or includes content related to the at least one first parameter, so that the first UE policy is determined for the terminal device based on the at least one first parameter supported by the terminal device.

For the at least one second parameter not supported by the terminal device indicated by the first information, the first UE policy does not include the at least one second parameter or does not include content related to the at least one second parameter, so that the content related to the at least one second parameter is excluded from the first UE policy, thereby preventing the first UE policy from containing content that the terminal device does not support or cannot identify.

After determining the first UE policy, the second network device sends the first UE policy to the first network device, and the first network device sends the received first UE policy to the terminal device.

Optionally, the second network device includes the first UE policy in the second UE policy container and sends the second UE policy container to the first network device, and the first network device transparently transmits the second UE policy container to the terminal device. At this time, a process of sending the first UE policy by the second network device to the terminal device via the first network device may refer to the UCU process illustrated in FIG. 3, and will not be repeatedly described here.

In the wireless communication method according to the embodiments of the present disclosure, the first UE policy configured by the second network device for the terminal device is determined based on the first information, and when the first information indicates the support capability of the terminal device for parameters related to the UE policy, the configured first UE policy is configured based on the support capability of the terminal device for the parameters related to the UE policy. This allows for targeted configuration of UE policy based on the capability of the terminal device, so that the UE policy can be supported effectively by the UE and/or content not supported by the terminal device in the UE policy is avoided, thereby improving the use efficiency of the UE policy by the terminal device.

In some embodiments, the wireless communication method provided by the terminal device further includes the following operation.

The terminal device receives second information from the first network device, wherein the second information is used to indicate at least one third parameter that is allowed or required to be used by the terminal device, and the at least one third parameter is determined based on the at least one first parameter and/or the at least one second parameter.

Correspondingly, the wireless communication method provided by the first network device further includes the following operation.

The first network device sends second information to the terminal device, wherein the second information is used to indicate at least one third parameter that is allowed or required to be used by the terminal device, and the at least one third parameter is determined based on the at least one first parameter and/or the at least one second parameter.

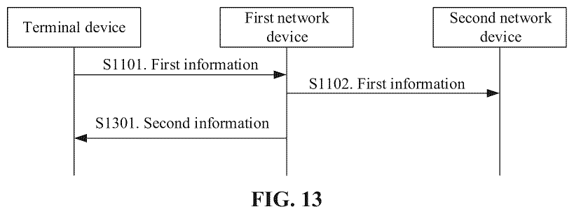

It is to be understood that the wireless communication method provided by the embodiments of the present disclosure, as illustrated in FIG. 13, further includes the following operations S1301, S1302 and S1303.

At S1301, the first network device sends the second information to the terminal device.

In an embodiment of the present disclosure, after the first network device has received the first information, the first network device may determine the second information based on the first information, and send the second information to the terminal device. The second information is used to indicate at least one third parameter that is allowed or required to be used by the terminal device, the third parameter is related to the UE policy, and the third parameter is determined based on the at least one first parameter and the at least one second parameter.

Optionally, a third parameter in the at least one third parameter satisfies at least one of the following conditions that:
the at least one first parameter includes the third parameter; or
the at least one second parameter does not include the third parameter.

For one third parameter in the at least one third parameter, it may be included in the at least one first parameter and/or may not be included in the at least one second parameter.

If the first information only indicates the at least one first parameter, the third parameter is included in the at least one first parameter indicated by the first information.

In an example, if the first information only indicates that the at least one first parameter supported by the terminal device includes application descriptors and IP descriptors, then the at least one third parameter may include the application descriptors.

If the first information only indicates the at least one second parameter, the third parameter is not included in the at least one second parameter indicated by the first information.

In an example, if the first information only indicates that the at least one second parameter not supported by the terminal device includes application descriptors and IP descriptors, then the at least one third parameter may include connectivity capabilities.

If the first information only indicates the at least one first parameter and the at least one second parameter, the third parameter is included in the at least one first parameter indicated by the first information, or is not included in the at least one second parameter indicated by the first information, or is included in the at least one first parameter indicated by the first information and is not included in the at least one second parameter indicated by the first information.

In an example, if the first information only indicates that the at least one parameter supported by the terminal device includes an SSC mode selection and application descriptors, and indicates that the at least one second parameter not supported by the terminal device includes connectivity capabilities and the SSC mode selection, then the at least one third parameter may include the application descriptors.

In the embodiments of the present disclosure, the terminal device receives second information from the first network device, determines at least one third parameter that is allowed to be used or required to be used based on the second information, and preferentially selects content associated with the at least one third parameter when selecting content in the UE policy. In an example, the third parameter belongs to the URSP parameter, and when the terminal device selects the URSP rule in the URSP, the terminal device preferentially selects a URSP rule whose URSP parameter includes at least one third parameter for searching or establishment of PDU session.

In the wireless communication method according to the embodiments of the present disclosure, the first network device sends to the terminal device second information for indicating at least one third parameter that is allowed or required to be used by the terminal device, so that the terminal device, after receiving the second information, selects the content of the UE policy based on the at least one third parameter, thereby improving the selection efficiency of the UE policy. Moreover, the content of the selected UE policy is selected according to the at least one third parameter, and thus the content of the selected UE policy can be supported or identified by the terminal device, thereby improving the execution efficiency of the UE policy.

In some embodiments, the first network device sends a third message to the terminal device, the third message carrying second information. The terminal device receives the third message sent by the first network device and obtains second information from the third message.

Optionally, the third message is used as a response to the first message carrying the first information.

In an example, the first message is a registration request message, and the third message is a registration reply message.

In an example, the first message is a UE policy configuration request message, and the third message is a UE policy configuration reply message.

Optionally, the third message may be a message which is triggered based on the first information and has no association relationship with the first message.

In some embodiments, a manner in which the first network device obtains the second information includes at least one of the following two manners:
obtaining manner 1: the first network device itself determines the second information;
obtaining manner 2: the first network device receives the second information from the second network device.

In the obtaining manner 1, the first network device determines the second information based on the first information.

It is to be understood that after the first network device has received the first information, the first network device sends the first information to the second network device, determines the second information according to the first information, and sends the second information to the terminal device.

In the obtaining manner 2, the first network device receives the second information from the second network device.

Correspondingly, the wireless communication method provided by the second network device further includes the following operation.

The second network device sends second information to the first network device. The second information is used to indicate at least one third parameter that is allowed or required to be used by the terminal device, the at least one third parameter being determined based on the at least one first parameter and/or the at least one second parameter.

It is to be understood that, on the basis of FIG. 13, the interaction between the first network device and the second network device further includes the operation S1302.

At S1302, the second network device sends the second information to the first network device.

Based on FIG. 13, it may be determined that after the first network device has received the first information, the first network device sends the first information to the second network device. After the second network device has received the first information, the second network device determines the second information according to the first information and sends the second information to the first network device. After the first network device has received the second information, the first network device sends the received second information to the terminal device.

In some embodiments, in the case where the first UE policy and the second information are received by the terminal device from the first network device, the second information is received before the first UE policy being received.

In an example, the terminal device sends first information to the first network device, and after the first network device has received the first information, the first network device determines second information based on the first information, and sends the second information to the terminal device. After the first network device has received the first UE policy from the second network device, the first network device sends the first UE policy to the terminal device.

In an example, the terminal device sends first information to the first network device, and after the first network device has received the first information, the first network device sends the first information to the second network device. The second network device determines the second information based on the first information and sends the second information to the first network device. After the first network device has received the first UE policy from the second network device, the first network device sends the first UE policy to the terminal device. After sending the second information to the first network device, the second network device determines a first UE policy based on the first information and sends the first UE policy to the first network device. The first network device sends the received first UE policy to the terminal device.

In the wireless communication method provided by the embodiments of the present disclosure, the second information may be determined by the first network device or the second network device, thereby improving the flexibility of implementation of the solution. When the second information is determined by the first network device, there is no need for interaction of the second information between the first network device and the second network device, thereby reducing transmission time of the second information, and reducing the network overhead.

The wireless communication method provided by the embodiments of the present disclosure will be further described as follows by taking the USRP parameter as an example.

In the related art, parameters in URSP rules, such as an application descriptor parameter in the traffic descriptor, may not be supported or identified by the terminal, resulting in a situation that some URSP rules issued by the network side may never be executed by the terminal, but the network side does not know this situation. Therefore, status information of execution of URSP rules is known only to the terminal device, but not to the network side, and thus it is uncertain whether the URSP parameters sent to the terminal are reasonable or used.

The embodiments of the present disclosure provide a wireless communication method, and provide a mechanism that helps the network side know which URSP parameters are supported by the terminal device, so that the network side (such as the PCF) can modify the URSP parameters according to the situation.

In the wireless communication method provided by the embodiments of the present disclosure, first information is introduced for identifying URSP parameters supported or not supported by the UE.

The first information may be used to identify whether the UE supports or does not support one or more parameters in the traffic descriptor, such as Application Descriptor, IP 3-Tuple, Connection Capability, and DNN.

The first information may be used to identify whether the UE supports or does not support one or more parameters in the RSD: parameters in Route Selection Component and/or parameters in Route Selection Validation Criteria (e.g., Time Window, Location Criteria).

The first information may be considered as a capability of the UE, that is, a capability of supporting a certain parameter of the URSP.

The UE reports the first information to the PCF through a UE policy container included in the uplink NAS message.

The UE includes the first information in the UE policy container and sends the UE policy container to the AMF through an uplink NAS message, and the AMF transparently transmits the UE policy container to the PCF or sends the first information in the UE Policy container to the PCF. The PCF determines the content of URSP according to the first information, and sends the URSP to the UE through a UE policy configuration process.

The uplink NAS message includes the following three types of messages.

### Message 1: Registration Request Message

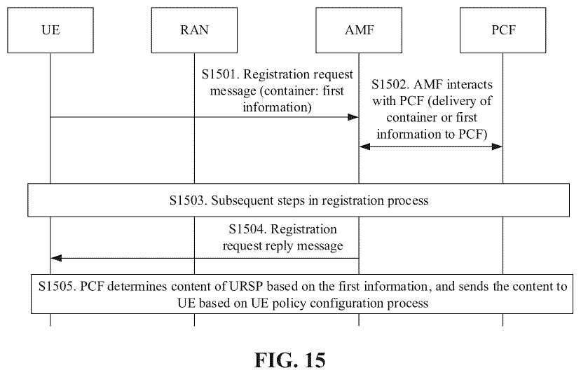

In a case where the uplink NAS message is the registration request message, the wireless communication method according to the embodiments of the present disclosure may be as illustrated in FIG. 15, which includes the following operations S1501 to S1505.

At S1501, UE sends a registration request to AMF.

The registration request message includes a container, and the container includes first information. The container is a UE policy container.

At S1502, the AMF interacts with PCF.

During the interaction between the AMF and the PCF, the AMF delivers the container or the first information to the PCF. If the AMF delivers the container to the PCF, the container may be the container in the registration request message, in which case the container is transparently transmitted to the PCF.

At S1503, the UE, the RAN, the AMF, and the PACF perform candidate steps of the registration process.

At S1504, the AMF sends a registration request reply message to the UE.

Optionally, the registration request response message includes URSP parameters allowed or required to be used by the UE.

At S1505, the PCF determines the content of URSP based on the first information, and sends the content of the URSP to the UE through the UCU process.

### Message 2: UE Policy Configuration Request Message

In a case where the uplink NAS message is the UE policy configuration request

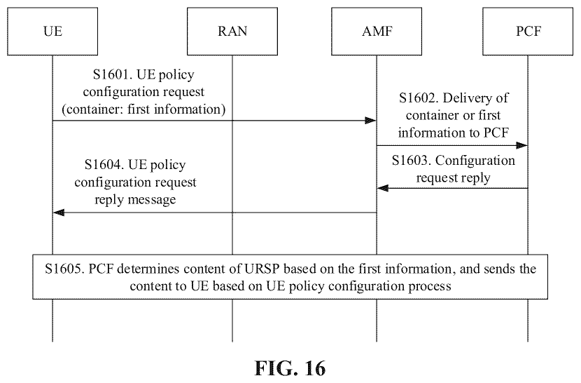

message, the wireless communication method provided by the embodiments of the present disclosure may be as illustrated in FIG. 16, which includes the following operations S1601 to S1605.

At S1601, UE sends a UE policy configuration request message to AMF.

The UE policy configuration request message includes a container, and the container includes first information. The container is a UE policy container.

At S1602, the AMF sends a configuration request message to PCF.

The AMF delivers the container or the first information to the PCF via the configuration request message.

At S1603, the PCF sends a configuration request reply message to the AMF.

Optionally, the configuration request reply message includes URSP parameters allowed or required to be used by the UE.

At S1604, the AMF sends a UE policy configuration reply message to the UE.

Optionally, the UE policy configuration reply message includes URSP parameters that are allowed or required to be used by the UE.

At S1605, the PCF determines content of URSP based on the first information, and sends the content of the URSP to the UE through the UCU process.

### Message 3: UL NAS Transport Message

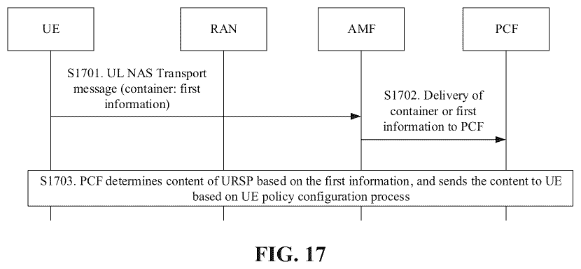

In a case where the uplink NAS message is the UL NAS transport message, the wireless communication method provided by the embodiments of the present disclosure may be as illustrated in FIG. 17, which includes the following operations S1701 to S1703.

At S1701, UE sends UL NAS transport message to AMF.

The UL NAS transport message includes a container, and the container includes first information. The container is a UE policy container.

At S1702, the AMF sends the container or the first information to PCF.

If the AMF delivers the container to the PCF, the container may be a container in the UL NAS transport message, in which case the container is transparently transmitted to the PCF.

At S1703, the PCF determines content of URSP based on the first information, and sends the content of the URSP to the UE through the UCU process.

In the embodiment of the present disclosure, the UCU process in FIG. 15, FIG. 16, and FIG. 17 may refer to FIG. 3, and will not be described in detail herein.

In practical applications, the wireless communication method provided by the embodiments of the present disclosure may also be applied to negotiation of other policies other than PCF. Further, the negotiation for the traffic type may not be limited to the use of the corresponding policy, and may be applicable to the mutual determination of supported/allowed traffics between the network and the UE.

Preferred embodiments of the present disclosure have been described in detail with reference to the accompanying drawings as described above, but the present disclosure is not limited to the specific details of the above embodiments. Various simple modifications may be made to the technical solution of the present disclosure within the scope of the technical concept of the present disclosure, and these simple modifications all belong to the scope of protection of the present disclosure. For example, each of the specific technical features described in the above specific embodiments may be combined in any suitable manner without contradiction, and various possible combinations are not further described in the present disclosure in order to avoid unnecessary repetition. For another example, any combination may be made between the various embodiments of the present disclosure so long as it does not depart from the idea of the present disclosure and is likewise to be regarded as the disclosure of the present disclosure. For another example, on the premise of no conflict, each embodiment described in the present disclosure and/or the technical features in each embodiment may be arbitrarily combined with the related art, and the technical solution obtained after combination should also fall within the scope of protection of the present disclosure.

It is to be understood that in various method embodiments of the present disclosure, the size of the sequence numbers in the above-mentioned processes does not mean the order of execution, and the execution order of each process is to be determined by its function and inherent logic, and should not be limited in any way to the implementation process of the embodiments of the present disclosure. Further, in embodiments of the present disclosure, the terms “downlink”, “uplink” and “sidelink” are used to denote that the transmission direction of signals or data, where “downlink” is used to denote the transmission direction of the signals or data is a first direction transmitted from the site to the user equipment of a cell, and “uplink” is used to denote that the transmission direction of the signal or data is a second direction transmitted from the user equipment of the cell to the site, “sidelink” is used to denote that the transmission direction of the signal or data is a first direction transmitted from a user equipment 1 to a user equipment 2. For example, “downlink signal” denotes that the transmission direction of the signal is the first direction. In the present disclosure, the term “and/or” is used to describe an association relationship of associated objects, and represents that there may be three relationships. Specifically, A and/or B may represent the following three situations: i.e., independent existence of A, existence of both A and B, and independent existence of B. In addition, the character “/” in the present disclosure generally represents that an “or” relationship is formed between the previous and next associated objects.

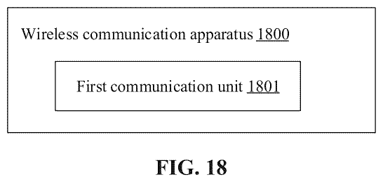

FIG. 18 is a structural composition diagram of a wireless communication apparatus provided by an embodiment of the present disclosure, and the wireless communication apparatus is applied to a terminal device. As illustrated in FIG. 18, the wireless communication apparatus 1800 includes a first communication unit 1801.

The first communication unit 1801 is configured to send first information to a first network device. Herein, the first information is used to indicate at least one first parameter supported by the terminal device and/or at least one second parameter not supported by the terminal device, the first parameter being related to a UE policy and the second parameter being related to the UE policy.

In some embodiments, the at least one first parameter belongs to a UE route selection policy (URSP) parameter.

In some embodiments, the at least one first parameter includes a parameter(s) in a traffic descriptor and/or a parameter(s) in a route selection descriptor.

In some embodiments, if the at least one first parameter includes the parameter(s) in the route selection descriptor, the at least one first parameter includes a parameter(s) in a route selection component and/or a parameter(s) in route selection validation criteria.

In some embodiments, the at least one second parameter belongs to a URSP parameter.

In some embodiments, the at least one second parameter includes a parameter(s) in a traffic descriptor and/or a parameter(s) in a route selection descriptor.

In some embodiments, if the at least one second parameter includes the parameter(s) in the route selection descriptor, the at least one second parameter includes a parameter(s) in a route selection component and/or a parameter(s) in route selection validation criteria.

In some embodiments, the first communication unit 1801 is further configured to send a first message to the first network device. Herein, the first message carries the first information.

In some embodiments, the first message includes a first UE policy container, and the first information is contained in the first UE policy container.

In some embodiments, the first message includes at least one of: a registration request message; a UE policy configuration request message; or an uplink non-access stratum (NAS) transport message.

In some embodiments, the first communication unit 1801 is further configured to receive a first UE policy from the first network device. Herein, the first UE policy is determined based on the first information.

In some embodiments, the first communication unit 1801 is further configured to receive second information from the first network device. Herein, the second information is used to indicate at least one third parameter that is allowed or required to be used by the terminal device, the at least one third parameter being determined based on the at least one first parameter and/or the at least one second parameter.

In some embodiments, a third parameter in the at least one third parameter satisfies at least one of the following conditions that:
the at least one first parameter includes the third parameter; or
the at least one second parameter does not include the third parameter.

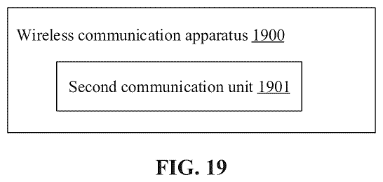

FIG. 19 is a structural composition diagram of a wireless communication apparatus provided by an embodiment of the present disclosure, and the wireless communication apparatus is applied to a first network device. As illustrated in FIG. 19, the wireless communication apparatus 1900 includes a second communication unit 1901.

The second communication unit 1901 is configured to receive first information from a terminal device. Herein, the first information is used to indicate at least one first parameter supported by the terminal device and/or at least one second parameter not supported by the terminal device, the first parameter being related to a UE policy and the second parameter being related to the UE policy.

The second communication unit 1901 is further configured to send the first information to a second network device.

In some embodiments, the at least one first parameter belongs to a UE route selection policy (URSP) parameter.

In some embodiments, the at least one first parameter includes a parameter(s) in a traffic descriptor and/or a parameter(s) in a route selection descriptor.

In some embodiments, if the at least one first parameter includes the parameter(s) in the route selection descriptor, the at least one first parameter includes a parameter(s) in route selection components and/or a parameter(s) in route selection validation criteria.

In some embodiments, the at least one second parameter belongs to a URSP parameter.

In some embodiments, the at least one second parameter includes a parameter(s) in a traffic descriptor and/or a parameter(s) in a route selection descriptor.

In some embodiments, if the at least one second parameter includes the parameter(s) in the route selection descriptor, the at least one second parameter includes a parameter(s) in route selection components and/or a parameter(s) in route selection validation criteria.

In some embodiments, the second communication unit 1901 is further configured to receive a first message from the terminal device. Herein, the first message carries the first information.

In some embodiments, the first message includes a first UE policy container, and the first information is contained in the first UE policy container.

In some embodiments, the first message includes at least one of: a registration request message; a UE policy configuration request message; or an uplink non-access stratum (NAS) transport message.

In some embodiments, the second communication unit 1901 is further configured to send a second message to the second network device. Herein, the second message carries the first information.

In some embodiments, the second message includes a first UE policy container, and the first information is contained in the first UE policy container; or

The first information is contained in the second message.

In some embodiments, the second communication unit 1901 is further configured to receive a first UE policy from the second network device, wherein the first UE policy is determined based on the first information; and
send the first information to the terminal device.

In some embodiments, the second communication unit 1901 is further configured to send second information to the terminal device. Herein, the second information is used to indicate at least one third parameter that is allowed or required to be used by the terminal device, the at least one third parameter being determined based on the at least one first parameter and/or the at least one second parameter.

In some embodiments, a third parameter in the at least one third parameter satisfies at least one of the following conditions that:
the at least one first parameter includes the third parameter; or
the at least one second parameter does not include the third parameter.

In some embodiments, the wireless communication apparatus 1900 further includes a first determination unit.

The first determination unit is configured to determine the second information based on the first information.

In some embodiments, the second communication unit 1901 is further configured to receive the second information from the second network device.

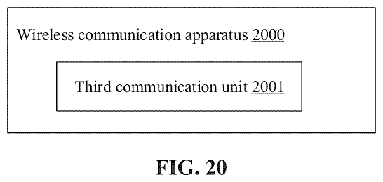

FIG. 20 is a structural composition diagram of a wireless communication apparatus provided by an embodiment of the present disclosure, and the wireless communication apparatus is applied to a second network device. As illustrated in FIG. 20, the wireless communication apparatus 2000 includes a third communication unit 2001.

The third communication unit 2001 is configured to receive first information from a first network device. Herein, the first information is used to indicate at least one first parameter supported by a terminal device and/or at least one second parameter not supported by the terminal device, the first parameter being related to a UE policy and the second parameter being related to the UE policy.

In some embodiments, the at least one first parameter belongs to a UE route selection policy (URSP) parameter.

In some embodiments, the at least one first parameter includes a parameter(s) in a traffic descriptor and/or a parameter(s) in a route selection descriptor.

In some embodiments, if the at least one first parameter includes the parameter(s) in the route selection descriptor, the at least one first parameter includes a parameter(s) in route selection components and/or a parameter(s) in route selection validation criteria.

In some embodiments, the at least one second parameter belongs to a URSP parameter.

In some embodiments, the at least one second parameter includes a parameter(s) in a traffic descriptor and/or a parameter(s) in a route selection descriptor.

In some embodiments, if the at least one second parameter includes the parameter(s) in the route selection descriptor, the at least one second parameter includes a parameter(s) in route selection components and/or a parameter(s) in route selection validation criteria.

In some embodiments, the third communication unit 2001 is further configured to receive a second message from the first network device. Herein, the second message carries the first information.

In some embodiments, the second message includes a first UE policy container, and the first information is contained in the first UE policy container; or
the first information is contained in the second message.

In some embodiments, the third communication unit 2001 is further configured to send a first UE policy to the first network device. Herein, the first UE policy is determined based on the first information.

In some embodiments, the third communication unit 2001 is further configured to send second information to the first network device. Herein, the second information is used to indicate at least one third parameter that is allowed or required to be used by the terminal device, the at least one third parameter being determined based on the at least one first parameter and/or the at least one second parameter.

In some embodiments, the third parameter satisfies at least one of the following conditions that:
the at least one first parameter includes the third parameter; or
the at least one second parameter does not include the third parameter.

It will be understood by those skilled in the art that the above description of the wireless communication apparatus of the embodiments of the present disclosure may be understood with reference to the description of the wireless communication method of the embodiments of the present disclosure.

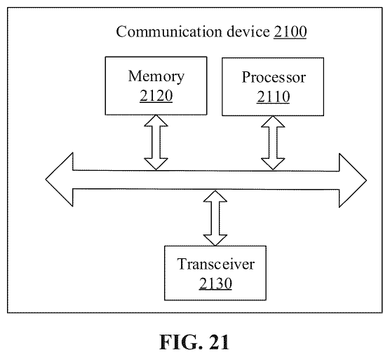

FIG. 21 is a schematic structural diagram of a communication device 2100 provided by an embodiment of the present disclosure. The communication device may be a terminal device, or may be a first network device, a second network device. The communication device 2100 illustrated in FIG. 21 includes a processor 2110 that may call and execute a computer program from a memory to implement the methods in the embodiments of the present disclosure.

Optionally, as illustrated in FIG. 21, the communication device 2100 may also include a memory 2120. The processor 2110 may call and execute a computer program from memory 2120 to implement the method in the embodiments of the present disclosure.

The memory 2120 may be a separate device independent of the processor 2110 or may be integrated in the processor 2110.

As illustrated in FIG. 21, the communication device 2100 may also include a transceiver 2130. The processor 2110 may control the transceiver 2130 to communicate with other devices, and in particular to send information or data to other devices, or to receive information or data sent by other devices.

The transceiver 2130 may include a transmitter and a receiver. The transceiver 2130 may further include antennas. The number of antennas may be one or more.

Optionally, the communication device 2100 may be specifically a first network device of the embodiments of the present disclosure, and the communication device 2100 may implement corresponding processes implemented by the first network device in various methods of the embodiments of the present disclosure, which will not be repeated here for the sake of brevity. The second communication unit in the first network device may be implemented by the transceiver 2130, and the first determination unit may be implemented by the processor 2110.

Optionally, the communication device 2100 may be specifically a second network device of the embodiments of the present disclosure, and the communication device 2100 may implement corresponding processes implemented by the second network device in various methods of the embodiments of the present disclosure, which will not be repeated here for the sake of brevity. The third communication unit in the second network device may be implemented by the transceiver 2130.

Optionally, the communication device 2100 may be specifically a mobile terminal/the terminal device of the embodiments of the present disclosure, and the communication device 2100 may implement corresponding processes implemented by the mobile terminal/the terminal device in various methods of the embodiments of the present disclosure, which will not be repeated here for the sake of brevity. The first communication unit in the terminal device may be implemented by the transceiver 2130.

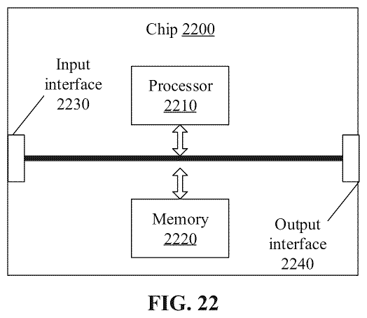

FIG. 22 is a schematic structural diagram of a chip according to an embodiment of the present disclosure. A chip 2200 illustrated in FIG. 22 includes a processor 2210 that may call and execute a computer program from a memory to implement the method in the embodiments of the present disclosure.

Optionally, as illustrated in FIG. 22, the chip 2200 may also include a memory 2220. The processor 2210 may call and execute a computer program from the memory 2220 to implement the method in the embodiments of the present disclosure.

The memory 2220 may be a separate device independent of the processor 2210 or may be integrated in the processor 2210.

Optionally, the chip 2200 may also include an input interface 2230. The processor 2210 may control the input interface 2230 to communicate with other devices or chips, and in particular to obtain information or data sent by other devices or chips.

Optionally, the chip 2200 may also include an output interface 2240. The processor 2210 may control the output interface 2240 to communicate with other devices or chips, and in particular output information or data to other devices or chips.

Optionally, the chip may be applied to be a first network device or a second network device of the embodiments of the present disclosure, and the chip may implement corresponding processes implemented by the first network device or the second network device in various methods of the embodiments of the present disclosure, which will not be repeated here for the sake of brevity.

Optionally, the chip may be applied to be a mobile terminal/the terminal device of an embodiment of the present disclosure, and the chip may implement corresponding processes implemented by the mobile terminal/the terminal device in respective methods of the embodiments of the present disclosure, which will not be repeated here for the sake of brevity.

It is to be understood that the chip referred to in the embodiments of the present disclosure may also be referred to as a system-level chip, a system chip, a chip system or a system-on-chip or the like.

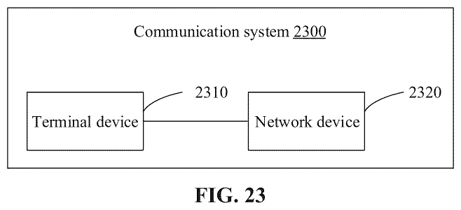

FIG. 23 is a schematic block diagram of a communication system 2300 provided by an embodiment of the present disclosure. As illustrated in FIG. 23, the communication system 2300 includes a terminal device 2310 and a network device 2320.

The terminal device 2310 may be configured to implement corresponding functions implemented by the terminal device in the above methods, and the network device 2320 may be configured to implement corresponding functions implemented by the first network device or the second network device in the above methods, which will not be repeated here for the sake of brevity.

According to the above technical solution, the terminal device sends first information to the first network device, the first information is used to indicate at least one first parameter supported by the terminal device and/or at least one second parameter not supported by the terminal device, the first parameter is related to the UE policy, and the second parameter is related to the UE policy. Therefore, the first information can reflect a support capability of the terminal device for at least one parameter related to the UE policy, so that based on reporting of the first information, the network side can obtain the support capability of the terminal for the at least one parameter related to the UE policy to adjust content of the UE policy of the terminal device according to the first information, thereby avoiding waste of resources caused by configuring, for the terminal device, the UE policy related parameters that are not supported by the terminal device.

It is to be understood that the processor may be an integrated circuit chip having signal processing capability. In implementation, the operations of the above method embodiments may be accomplished by integrated logic circuitry of hardware in processor or instructions in the form of software. The processor may be a general purpose processor, a digital signal processor (DSP), an application specific integrated circuit (ASIC), a field programmable gate array (FPGA) or other programmable logic devices, discrete gates or transistor logic devices, or discrete hardware components. The processor may implement or execute the methods, operations and logic diagrams disclosed in the embodiments of the present disclosure. The general purpose processor may be a microprocessor or any conventional processor. The operations of the method disclosed in the embodiments of the present disclosure may be directly embodied as being executed by a hardware decoding processor or being executed by the hardware and software modules in a decoding processor. The software modules may be located in a storage medium mature in the art, such as a random access memory, a flash memory, a read-only memory, a programmable read-only memory or an electrically erasable programmable memory, a register, etc. The storage medium is located in the memory, and the processor reads the information in the memory to complete the operations of the aforementioned method in conjunction with its hardware.

It will be appreciated that the memory in the embodiments of the present disclosure may be a volatile memory or a non-volatile memory, or may also include both a volatile memory and a non-volatile memory. The non-volatile memory may be a read-only memory (ROM), a programmable ROM (PROM), an erasable PROM (EPROM), an electrically EPROM (EPROM) or a flash memory. The volatile memory may be a random access memory (RAM), which serves as an external cache. By way of illustration but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM). It is to be noted that the memory in the systems and methods described herein is intended to include, but is not limited to, these memories and any other suitable types of memory.

It is to be understood that the memory described above is exemplary but not limiting. For example, the memory in the embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synchronous link DRAM (SLDRAM), a direct rambus RAM (DR RAM), etc. That is, the memory in the embodiments of the present disclosure is intended to include, but is not limited to, these memories and any other suitable types of memory.

In an embodiment of the present disclosure, there is further provided a computer-readable storage medium, configured to store a computer program.

Optionally, the computer-readable storage medium may be applied to the first network device or the second network device of the embodiments of the present disclosure, and the execution of the computer program causes a computer to implement corresponding processes implemented by the first network device or the second network device in the methods of the embodiments of the present disclosure, which will not be repeated here for the sake of brevity.

Optionally, the computer-readable storage medium may be applied to the mobile terminal/the terminal device of the embodiments of the present disclosure, and the execution of the computer program causes a computer to implement corresponding processes implemented by the mobile terminal/the terminal device in the methods of the embodiments of the present disclosure, which will not be repeated here for the sake of brevity.

In an embodiment of the present disclosure, there is further provided a computer program product, which includes computer program instructions.

Optionally, the computer program product may be applied to the first network device or the second network device of the embodiments of the present disclosure, and the execution of the computer program instructions causes a computer to implement corresponding processes implemented by the first network device or the second network device in the methods of the embodiments of the present disclosure, which will not be repeated here for the sake of brevity.

Optionally, the computer program product may be applied to the mobile terminal/the terminal device of the embodiments of the present disclosure, and the execution of the computer program instructions causes a computer to implement corresponding processes implemented by the mobile terminal/the terminal device in the methods of the embodiments of the present disclosure, which will not be repeated here for the sake of brevity.

In an embodiment of the present disclosure, there is further provided a computer program.

Optionally, the computer program may be applied to the first network device or the second network device of the embodiments of the present disclosure, the computer program, when running on a computer, causes the computer to implement corresponding processes implemented by the first network device or the second network device in the methods of the embodiments of the present disclosure, which will not be repeated here for the sake of brevity.

Optionally, the computer program may be applied to the mobile terminal/the terminal device of the embodiments of the present disclosure, the computer program, when running on a computer, causes the computer to implement corresponding processes implemented by the mobile terminal/the terminal device in the methods of the embodiments of the present disclosure, which will not be repeated here for the sake of brevity.

Those of ordinary skill in the art may realize that the various example units and algorithm steps described in connection with the embodiments disclosed herein may be implemented in electronic hardware or a combination of computer software and electronic hardware. Whether these functions are performed in hardware or software depends on the specific application and design constraints of the technical solution. Professionals may use different methods for each particular application to implement the described functionality, but such implementation should not be considered beyond the scope of the present disclosure.

Those skilled in the art will clearly appreciate that, for convenience and conciseness of description, the specific operating processes of the above-described systems, apparatuses and units may refer to the corresponding processes in the aforementioned method embodiments and will not be repeated herein.

In several embodiments provided herein, it is to be understood that the disclosed systems, apparatuses and methods may be implemented in other manners. For example, the above-described apparatus embodiments are only schematic, for example, the division of the units is only a logical functional division, and in practice, there may be another division manner, for example, multiple units or components may be combined or integrated into another system, or some features may be ignored or not performed. On the other hand, the coupling or direct coupling or communication connection between each other illustrated or discussed may be indirect coupling or communication connection through some interfaces, devices or units, and may be electrical, mechanical or other form.

The units illustrated as separate elements may or may not be physically separated, and the elements displayed as units may or may not be physical units, i.e. they may be located in a place, or may be distributed over a plurality of network units. Part or all of the units may be selected according to the actual needs to achieve the purpose of the embodiments of the present disclosure.

In addition, various functional units in various embodiments of the present disclosure may be integrated in one processing unit, and each unit may exist physically alone, or two or more units may be integrated in one unit.

When the functions are realized in the form of software functional units and sold or used as an independent product, they may be stored in a computer readable storage medium. Based on such an understanding, the technical solutions according to the disclosure, in essence or the part contributing to the prior art, or part of the technical solutions can be embodied in the form of a software product. The computer software product is stored in a storage medium, and includes several instructions so that a computer device (which may be a personal computer, a server, a network device or the like) implements all or part of the method according to respective embodiments of the disclosure. The aforementioned storage medium includes various media capable of storing a program code such as a USB disk, a mobile hard drive disk, a read-only memory (ROM), a random access memory (RAM), a magnetic disk or an optical disk.

The above is only the specific implementation of the present disclosure, but the scope of protection of the present disclosure is not limited thereto. Any person skilled in the art may easily think of changes or substitutions within the technical scope disclosed in the present disclosure, which is to be covered within the protection scope of the present disclosure. Therefore, the scope of protection of the present disclosure shall be subject to the scope of protection of the claims.

1. A terminal device, comprising:
a processor, a memory for storing a computer program, and a transceiver, wherein the processor is configured to call and execute the computer program stored in the memory to:
send first information to a first network device through the transceiver, wherein the first information is used to indicate at least one first parameter supported by the terminal device and/or at least one second parameter not supported by the terminal device, the at least one first parameter being related to a user equipment (UE) policy and the at least one second parameter being related to the UE policy.

2. The terminal device of claim 1, wherein the at least one first parameter belongs to a UE route selection policy (URSP) parameter.

3. The terminal device of claim 2, wherein the at least one first parameter comprises a parameter(s) in a traffic descriptor and/or a parameter(s) in a route selection descriptor.

4. The terminal device of claim 3, wherein if the at least one first parameter comprises the parameter(s) in the route selection descriptor, the at least one first parameter comprises a parameter(s) in route selection components and/or a parameter(s) in route selection validation criteria.

5. The terminal device of claim 1, wherein the at least one second parameter belongs to a URSP parameter.

6. The terminal device of claim 5, wherein the at least one second parameter comprises a parameter(s) in a traffic descriptor and/or a parameter(s) in a route selection descriptor.

7. The terminal device of claim 6, wherein if the at least one second parameter comprises the parameter(s) in the route selection descriptor, the at least one second parameter comprises a parameter(s) in route selection components and/or a parameter(s) in route selection validation criteria.

8. The terminal device of claim 1, wherein the processor is specifically configured to:
send a first message to the first network device through the transceiver, wherein the first message carries the first information.

9. The terminal device of claim 8, wherein the first message comprises a first UE policy container, and the first information is contained in the first UE policy container.

10. The terminal device of claim 8, wherein the first message comprises at least one of:
a registration request message;
a UE policy configuration request message; or
an uplink non-access stratum (NAS) transport message.

11. The terminal device of claim 1, wherein the processor is further configured to:
receive a first UE policy from the first network device through the transceiver, wherein the first UE policy is determined based on the first information.

12. The terminal device of claim 1, wherein the processor is further configured to:
receive second information from the first network device through the transceiver, wherein the second information is used to indicate at least one third parameter that is allowed or required to be used by the terminal device, the at least one third parameter being determined based on the at least one first parameter and/or the at least one second parameter.

13. The terminal device of claim 12, wherein a third parameter in the at least one third parameter satisfies at least one of the following conditions that:
the at least one first parameter comprises the third parameter; or
the at least one second parameter does not comprise the third parameter.

14. A first network device, comprising:
a processor, a memory for storing a computer program, and a transceiver, wherein the processor is configured to call and execute the computer program stored in the memory to:
receive first information from a terminal device through the transceiver, wherein the first information is used to indicate at least one first parameter supported by the terminal device and/or at least one second parameter not supported by the terminal device, the at least one first parameter being related to a user equipment (UE) policy and the at least one second parameter being related to the UE policy; and
send the first information to a second network device through the transceiver.

15. The first network device of claim 14, wherein the processor is specifically configured to:
receive a first message from the terminal device through the transceiver, wherein the first message carries the first information.

16. The first network device of claim 15, wherein the first message comprises a first UE policy container, and the first information is contained in the first UE policy container.

17. The first network device of claim 16, wherein the processor is specifically configured to:
send a second message to the second network device through the transceiver, wherein the second message carries the first information.

18. The first network device of claim 17, wherein
the second message comprises a first UE policy container, and the first information is contained in the first UE policy container; or
the first information is contained in the second message.

19. The first network device of claim 14, wherein the processor is further configured to:
receive a first UE policy from the second network device through the transceiver, wherein the first UE policy is determined based on the first information; and
send the first UE policy to the terminal device through the transceiver.

20. The first network device of claim 14, wherein the processor is further configured to:
send second information to the terminal device through the transceiver, wherein the second information is used to indicate at least one third parameter that is allowed or required to be used by the terminal device, the at least one third parameter being determined based on the at least one first parameter and/or the at least one second parameter.
